(19) United States
(12) Patent Application Publication
(10) Pub. No.: US 2024/0248442 A1
(43) Pub. Date: Jul. 25, 2024

(54) COMPUTER-IMPLEMENTED METHOD FOR APPLYING A GLUTAMINE SYNTHETASE INHIBITOR ON AN AGRICULTURAL FIELD

(71) Applicant: BASF SE, Ludwigshafen (DE)

(72) Inventors: Anna SOYK, Neustadt (DE); Elke BREITINGER, Limburgerhof (DE); Anja SIMON, Limburgerhof (DE)

(21) Appl. No.: 18/290,539

(22) PCT Filed: May 20, 2022
(86) PCT No.: PCT/EP2022/063797

§ 371 Date: Nov. 14, 2023

(30) Foreign Application Priority Data
May 21, 2021 (EP) 21175343.9

(51) Int. Cl. G05B 15/02

(52) U.S. Cl. CPC G05B 15/02

(57) ABSTRACT

Computer-implemented method for providing application data for an agricultural field, comprising the following steps: providing an application rate model for a plant, wherein the application rate model is configured to describe a relationship between a nitrogen content and an application rate of a glutamine synthetase inhibitor (S10): obtaining nitrogen content data of at least a section of the agricultural field (S20); providing the nitrogen content data of the at least one section of the agricultural field to the application rate model (S30); determining the application rate of the glutamine synthetase inhibitor of the at least one section of the agricultural field using the application rate model (S40); providing the application rate of the glutamine synthetase inhibitor for the at least one section of the agricultural field (S50).

### TECHNICAL FIELD

The present disclosure relates to a computer-implemented method for providing application data for an agricultural field, a use of satellite image data and/or nitrogen content data in such a method, a system for providing application rate data for an agricultural field and a computer program element for such a method.

### TECHNICAL BACKGROUND

Due to the rising world population, the demand for efficiency in agriculture increases. Agricultural products such as herbicides are indispensable in agriculture due to their impact on yield and have a significant impact on environmental aspects. The application of agricultural products on an agricultural field is therefore an important issue in agricultural. However, the yield is countered by the burden on the environment. Recommendations how to apply the herbicide vary from theoretical basis in form of written documents to observations in form of human experts. It has been found that a further need exists for a more accurate method for applying herbicides on the agricultural field.

### SUMMARY OF THE INVENTION

It is an object of the present invention to provide a method for providing application data for an agricultural field. These and other objects, which become apparent upon reading the following description, are solved by the subject matter of the independent claims. The dependent claims refer to preferred embodiments of the invention.

According to a first aspect of the present disclosure a computer-implemented method for providing application data for an agricultural field is provided, comprising the following steps: providing an application rate model for a plant, wherein the application rate model is configured to describe a relationship between a nitrogen content and an application rate of a glutamine synthetase inhibitor (e.g. glufosinate or a salt thereof); obtaining nitrogen content data of at least a section of the agricultural field; providing the nitrogen content data of the at least one section of the agricultural field to the application rate model; determining the application rate of the glutamine synthetase inhibitor (e.g. glufosinate or a salt thereof) of the at least one section of the agricultural field using the application rate model; providing the application rate of the glutamine synthetase inhibitor (e.g. glufosinate or a salt thereof) for the at least one section of the agricultural field.

A further aspect of the present disclosure relates to an apparatus for providing application data for an agricultural field is provided, the apparatus comprising:
one or more computing nodes and one or more computer-readable media having thereon computer-executable instructions that are structured such that, when executed by the one or more computing nodes, cause the apparatus to perform the following steps:
providing an application rate model for a plant, wherein the application rate model is configured to describe a relationship between a nitrogen content and an application rate of a glutamine synthetase inhibitor (e.g. glufosinate or a salt thereof); obtaining nitrogen content data of at least a section of the agricultural field; providing the nitrogen content data of the at least one section of the agricultural field to the application rate model; determining the application rate of the glutamine synthetase inhibitor (e.g. glufosinate or a salt thereof) of the at least one section of the agricultural field using the application rate model; providing the application rate of the glutamine synthetase inhibitor (e.g. glufosinate or a salt thereof) for the at least one section of the agricultural field.

The term agricultural field is to be understood broadly in the present case and comprises an area which is configured to serve as basis for growing of agricultural goods, e.g. soy or crop. The agricultural field may comprise any shape or size. The agricultural field is not limited to a continuous area. The agricultural field may vary in its biological characteristics and therefore its soil may also have different biological characteristics. The term application data is to be understood broadly in the present case and comprises plant data, application rates, herbicide data, field data, weather data etc. The term application rate model is to be understood broadly in the present case and comprises mathematical relations between input parameters and output parameters. The input parameters may comprise physical properties of a plant (e.g. nitrogen content), physical properties of a soil in the agricultural field (e.g. pH value, nitrogen content), and weather data (e.g. humidity, temperature etc.). The output parameters may comprise application rates, application time, application frequencies, etc. The mathematical relations may comprise factors, offsets, linear and non-linear equations, statistical models, conditions, neural networks, mathematical algorithms. For each plant a corresponding application rate model may exist. The term plant is to be understood broadly in the present case and comprises any plant which is used in agriculture. Exemplary plants are crop, soy, corn, tobacco etc. The plant may be surrounded by weed. The term application rate means in the present case preferably an amount of n glutamine synthetase inhibitor, like glufosinate or a salt thereof, per area. The amount may be expressed in weight (e.g. g, kg) or volume (e.g. dm³, m³). The area may be expressed in hectare, square meter, square miles, square kilometers etc. The application rate may be determined by a calculation unit using the application rate model. The term nitrogen content (and the synonymously used term “amount of nitrogen”) may both relate to an absolute and a relative value, e.g. a concentration. The term nitrogen content data is to be understood broadly in the present case and comprises beside the nitrogen content any data related to the nitrogen content. Exemplary nitrogen content data comprises meta data, time, location of the plant or the soil, plant data. The nitrogen content data may be derived from the plant and/or a soil adjacent to the plant and/or image data of the plant and/or the soil. The nitrogen content data may be derived by a measurement of a measurement device. The nitrogen content data may relate to single plants or a plurality of plants or sections of an agricultural field or the entire agricultural field. The term section is to be understood broadly in the present case and comprises any parts of an agricultural field. The term section is not limited by an area size. The section may comprise any shape and any area size. The term section may comprise geographical data such as coordinates for an unambiguous determination of the position, shape and area size of the section. The section comprises plants and soil. The determined application rate may be provided to a control for further processing, e.g. a control of an agricultural vehicle or of an application device. Obtaining the nitrogen content data and inputting the nitrogen contain data may also be carried out in one single step by automatically routing the nitrogen content data as input to the application rate model. Notably, even if in the present disclosure, the basic principles are explained based on the herbicide glufosinate, other glutamine synthetase inhibitors can be applied/used within the present disclosure. For example, the herbicide Bialaphos is also known as glutamine synthetase inhibitor. The term glutamine synthetase inhibitor has to be understood broadly in the context of the present disclosure and comprises all substances or mixtures providing such an inhibitor function.

In other words, the invention is based on the knowledge that there is a statistical significance between the efficiency of a glutamine synthetase inhibitor, like glufosinate or a salt thereof, and the nitrogen content of a plant. For example, glufosinate ammonium is a total herbicide which directly interferes and inhibits the nitrogen metabolism of plants. Being a structural analog to the plant intrinsic amino acid glutamate it binds into the pocket of the enzyme glutamine synthetase and thereby inhibits the last step of nitrogen fixation. The nitrogen homeostasis of plants is dependent on the intrinsic status and sensing of nitrogen availability. In consequence for example by a low nitrogen content in a plant a little application rate of a glutamine synthetase inhibitor, like the herbicide glufosinate ammonium, has the same effect on weed killing. In case the plant has a high nitrogen content a higher application rate of the glutamine synthetase inhibitor, e.g. the herbicide glufosinate ammonium, is necessary to delete weeds. By determining the nitrogen content of the plant an optimized application can be determined with the application rate model of the plant such that on the side the weed is efficiently deleted and on the other side the environment is minimally burdened. This may be advantageous in terms of cost due to reduced use of herbicide, in terms of efficiency due optimal yield, and in terms of environmental aspects due reduced use of herbicide.

In an embodiment, the nitrogen content data is derived by a measurement of the nitrogen content of a plant or a part of the plant which is within the at least one section of the agricultural field. Moreover, such measurements may not only be carried out with respect to the plant or a part of the plant, the nitrogen content in the soil around or at least partially around a plant may also be measured. The measurement may be carried out by a measurement device mounted on an agricultural vehicle. The measurement device may be a Near-infrared spectroscopy (NIR) sensor. However, other measurement methods can also be used as an alternative or in addition, which allow conclusions to be drawn about the nitrogen content, for example, by measuring the green content or the plant pigmentation. The measurement may be carried out in real time during an application. By measuring the nitrogen content of the plant or part of the plant accurate nitrogen content are determined. This may be advantageous in terms of determining the optimal application rate of a glutamine synthetase inhibitor, like glufosinate or a salt thereof, for the plant.

In an embodiment, the nitrogen content data is derived by a measurement of the nitrogen content of a soil or a part of the soil which is within the at least one section of the agricultural field. The measurement may be carried out by satellite imaging and/or NIR sensing. The measurement by satellite imaging may be advantageous in terms efficiency of data collection, as large areas can be simultaneously investigated. Exemplary the nitrogen content data is derived from more than one measurement device, e.g. NIR sensor and satellite imaging. This may be advantageous in terms of accuracy for determination of the nitrogen content.

In an embodiment, a method is provided, wherein the nitrogen content data is derived by an analysis of the satellite image data of the at least one section of the agricultural field, wherein the satellite image data comprises geographical location data and image data of the least one section of the agricultural field. Due to the subdivision of the agricultural field in sections an efficient and accurate way of determining the nitrogen content is provided. The different nitrogen contents of the sections may serve for a plausibility check of the measurements of satellite imaging.

In an embodiment, the nitrogen content data is derived by a measurement with a NIR spectrometry sensor of the nitrogen content of a plant or a part of the plant which is within the at least one section of the agricultural field. The NIR spectrometry sensor may be mounted on agricultural vehicle, a sprayer, agricultural robot or a drone. The measurement with a NIR spectrometry sensor can be carried regardless of the weather. The measurement may be carried out during a treatment of the agricultural field and directly provided to a control of an application unit for applying glutamine synthetase inhibitor, e.g. the herbicide Bialaphos, glufosinate and/or a salt thereof.

In an embodiment, the application rate of the glutamine synthetase inhibitor, e.g. glufosinate or a salt thereof, for the section of the agricultural field comprises a minimum value and a maximum value. The minimum value may be directly derived from the necessary amount of the glutamine synthetase inhibitor, e.g. glufosinate or a salt thereof, for a sufficient treatment of the plant. The maximum value may be derived from state regulations which may include minimum and maximum value matrices for specific weeds. The specification of a minimum value and a maximum value may allow user to adjust the application rate in consideration of other environmental parameters, e.g. wind, humidity, temperature, a relation between humidity and/or temperature with adjuvant concentration, etc. This may be advantageous in terms of efficiency.

In an embodiment, the application rate model is based on the correlation that within a minimum value and a maximum value of an application rate of the glutamine synthetase inhibitor, e.g. glufosinate or a salt thereof, for the section of the agricultural field, a higher application rate is determined for sections with higher nitrogen content compared to sections with lower nitrogen content.

In an embodiment, a method is provided, further comprising providing an application rate map for the agricultural field, wherein the application rate map is determined based on the at least one determined application rate for the section of the agricultural field. The term application rate means in the present case a map comprising at least one section with geographical coordinates and at least one application rate of glutamine synthetase inhibitor, e.g. glufosinate or a salt thereof. The application rate map may be provided to a control of an application device for a glutamine synthetase inhibitor, e.g. glufosinate or a salt thereof. This may allow an autonomous or automated and accurate treatment of the plants with a glutamine synthetase inhibitor, e.g. glufosinate or a salt thereof.

In an embodiment, the application rate map comprises different sections of the agricultural field with different application rates. This may increase the level of detail of the application rate map and therefore the efficiency of the treatment with a glutamine synthetase inhibitor, e.g. glufosinate or a salt thereof.

Glufosinate (CAS Reg. No. 51276-47-2), with IUPAC-Name (2RS)-2-amino-4-[hydroxy-(methyl)phosphinoyl]butyric acid, or 4-[hydroxy(methyl)phosphinoyl]-DL-homoalanine) or DL-4-[hydroxyl(methyl)phosphinoyl]-DL-homoalaninate, is known, as well as agronomically acceptable salts thereof, in particular glufosinate-ammonium (IUPAC-Name: ammonium (2RS)-2-amino-4-(methylphosphinato)butyric acid, CAS Reg. No. 77182-82-2). U.S. Pat. No. 4,168,963 describes phosphorus-containing compounds with herbicidal activity, of which, in particular, phosphinothricin (2-amino-4-[hydroxy(methyl)phosphinoyl]butanoic acid; common name: glufosinate) and its salts have acquired commercial importance in the agrochemistry (agricultural chemistry) sector. For example, glufosinate and its salts—such as glufosinate ammonium—and its herbicidal activity have been described e.g. by F. Schwerdtle et al. Z. Pflanzenkr. Pflanzenschutz, 1981, Sonderheft IX, pp. 431-440.

Glufosinate as racemate and its salts are commercially available under the trade-names Basta™ and Liberty™.

Glufosinate is represented by the following structure (I):

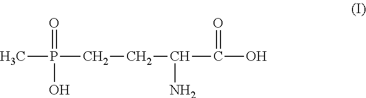

The compound of formula (I) is a racemate.

Glufosinate is a racemate of two enantiomers, out of which only one shows sufficient herbicidal activity (see e.g. U.S. Pat. No. 4,265,654 and JP92448/83). Even though various methods to prepare L-glufosinate (and respective salts) are known, the mixtures known in the art do not point at the stereochemistry, meaning that the racemate is present (e.g. WO 2003024221, WO2011104213, WO 2016113334, WO 2009141367).

In one embodiment, the method according to the present disclosure relates to racemic glufosinate mixtures as described above, wherein the glufosinate comprises about 50% by weight of the L-enantiomer and about 50% by weight of the D-enantiomer. In another embodiment, the method relates to glufosinate, wherein at least 70% by weight of the glufosinate is L-glufosinate or a salt thereof.

L-glufosinate, with IUPAC-Name (2S)-2-amino-4-[hydroxy(methyl)phosphinoyl]butyric acid (CAS Reg. No. 35597-44-5) and also called glufosinate-P, can be obtained commercially or may be pre-pared for example as described in WO2006/104120, U.S. Pat. No. 5,530,142, EP0248357A2, EP0249188A2, EP0344683A2, EP0367145A2, EP0477902A2, EP0127429 and J. Chem. Soc. Perkin Trans. 1, 1992, 1525-1529.

Preferably, the salts of glufosinate or (L)-glufosinate are the sodium, potassium or ammonium (NH4+) salts of glufosinate or L-glufosinate, in particular glufosinate-P-ammonium (IUPAC-Name: ammonium (2S)-2-amino-4-(methylphosphinato)butyric acid, CAS Reg. No. 73777-50-1), glufosinate-P-sodium (IUPAC-Name: sodium (2S)-2-amino-4-(methylphosphinato)butyric acid; CAS Reg. No. 70033-13-5) and glufosinate-P-potassium (IUPAC-Name: potassium (2S)-2-amino-4-(methylphosphinato)butyric acid) for L-glufosinate.

Hence, methods according to the present disclosure may relate to (L)-glufosinate-ammonium or (L)-glufosinate-sodium or (L)-glufosinate-potassium as (L)-glufosinate salts and (L)-glufosinate as free acid, preferably (L)-glufosinate. Especially preferred are methods relating to herbicidal compositions, which contain (L)-glufosinate-ammonium, i.e. the ammonium (NH4+) salt of glufosinate.

The term “glufosinate” as used in the present disclosure typically comprises, in one embodiment of the present disclosure, about 50% by weight of the L-enantiomer and about 50% by weight of the D-enantiomer; and in another embodiment of the present disclosure, more than 70% by weight of the L-enantiomer; preferably more than 80% by weight of the L-enantiomer; more preferably more than 90% of the L-enantiomer, most preferably more than 95% of the L-enantiomer and can be prepared as referred to above.

In an embodiment, glufosinate ammonium is applied. Glufosinate ammonium is a total herbicide which directly interferes and inhibits the nitrogen metabolism of plants. Being a structural analog to the plant intrinsic amino acid glutamate it binds into the pocket of the enzyme glutamine syntheses and thereby inhibits the last step of nitrogen fixation. The nitrogen homeostasis of plants is dependent on the intrinsic status and sensing of nitrogen availability.

In an embodiment, the plant is crop or soy. Exemplary, the plant may be corn or tobacco.

The methods of the present disclosure are suitable for combating/controlling common harmful plants in fields, where useful plants shall be planted (i.e. in crops). The inventive methods are generally suitable, such as for burndown of undesired vegetation, in fields of the following crops: Grain crops, including e.g. cereals (small grain crops) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare); maize (corn; Zea mays); sorghum (e.g. Sorghum bicolour); rice (Oryza spp. such as Oryza sativa and Oryza glaberrima); and sugar cane;
Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (lens culinaris var.); brassicaceae, including e.g. canola (Brassica napus), oilseed rape (OSR, Brassica napus), cabbage (B. oleracea var.), mustard such as B. juncea, B. campestris, B. narinosa, B. nigra and B. tournefortii; and turnip (Brassica rapa var.);
other broadleaf crops including e.g. sunflower, cotton, flax, linseed, sugarbeet, potato and tomato; TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;
turf, pasture and rangeland;
onion and garlic;
bulb ornamentals such as tulips and narcissus;
conifers and deciduous trees such as pinus, fir, oak, maple, dogwood, hawthorne, crabapple, and rhamnus (buckthorn); and
garden ornamentals such as roses, petunia, marigold and snapdragon.

In one embodiment, the method for controlling undesired vegetation is applied in cultivated rice, maize, pulse crops, cotton, canola, small grain cereals, soybeans, peanut, sugarcane, sunflower, plantation crops, tree crops, nuts or grapes. In another embodiment, the method is applied in cultivated crops selected from glutamine synthetase inhibitor tolerant crops, e.g. glufosinate-tolerant crops.

The methods according to the present disclosure are in particular suitable for burndown of undesired vegetation in fields of the following crop plants: small grain crops such as wheat, barley, rye, triticale and durum, rice, maize (corn), sugarcane, sorghum, soybean, pulse crops such as pea, bean and lentils, peanut, sunflower, sugarbeet, potato, cotton, brassica crops, such as oilseed rape, canola, mustard, cabbage and turnip, turf, pasture, rangeland, grapes, pomefruit, such as apple and pear, stonefruit, such as peach, almond, walnut, pecans, olive, cherry, plum and apricot, citrus, coffee, pistachio, garden ornamentals, such as roses, petunia, marigold, snap dragon, bulb ornamentals such as tulips and narcissus, conifers and deciduous trees such as pinus, fir, oak, maple, dogwood, hawthorne, crabapple and rhamnus.

The methods of the present disclosure are most suitable for burndown of undesired vegetation in fields of the following crop plants: small grain crops such as wheat, barley, rye, triticale and durum, rice, maize, sugarcane, soybean, pulse crops such as pea, bean and lentils, peanut, sunflower, cotton, brassica crops, such as oilseed rape, canola, turf, pasture, rangeland, grapes, stonefruit, such as peach, almond, walnut, pecans, olive, cherry, plum and apricot, citrus and pistachio.

The methods of the present disclosure have an outstanding performance against a broad spectrum of economically important harmful monocotyledonous and dicotyledonous harmful plants. Also here, post-emergence application is preferred.

Specifically, examples may be mentioned of some representatives of the monocotyledonous and dicotyledonous weed flora which can be controlled by the methods according to the present disclosure, without the enumeration being a restriction to certain species.

In the context of the present text, reference may be made to growth stages according to the BBCH monograph “Growth stages of mono- and dicotyledonous plants”, 2nd edition, 2001, ed. Uwe Meier, Federal Biological Research Centre for Agriculture and Forestry (Biologische Bundesanstalt für Land und Forstwirtschaft).

Examples of monocotyledonous harmful plants on which the glufosinate combinations act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Particular examples of monocotyledonous harmful plants species on which the herbicidal compositions act efficiently are selected from amongst the species Hordeum murinum, Echinochloa crusgalli, Poa annua, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

In a preferred embodiment, the herbicidal compositions are used to control monocotyledonous harmful plant species, more preferably monocoty-ledonous plants of the species Echinochloa spp., Digitaria spp., Setaria spp., Eleusine spp. and Brachiarium spp.

Examples of dicotyledonous harmful plants on which the herbicidal compositions act efficiently are from amongst the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the herbicidal compositions act efficiently are selected from amongst the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia caulescens, Sisymbrium irio, Sesbania exaltata, Capsella bursapastoris, Sonchus oleraceus, Euphorbia maculate, Helianthus annuus, Coronopus didymus, Salsola tragus, Abutilon theophrasti, Vicia benghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

In a preferred embodiment, the herbicidal compositions are used to control dicotyledonous harmful plant species, more preferably dicotyledonous plants of the species Amaranthus spp., Erigeron spp., Conyza spp., Kochia spp. and Abutilon spp.

Herbicidal compositions are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), Cyperus difformis, Cyperus difformis L., Cyperus esculentus, Cyperus ferax, Cyperus flavus, Cyperus iria, Cyperus lanceolatus, Cyperus odoratus, Cyperus rotundus, Cyperus serotinus Rottb., Eleocharis acicularis, Eleocharis kuroguwai, Fimbristylis dichotoma, Fimbristylis miliacea, Scirpus grossus, Scirpus juncoides, Scirpus juncoides Roxb, Scirpus or Bolboschoenus maritimus, Scirpus or Schoenoplectus mucronatus, Scirpus planiculmis Fr. Schmidt and the like.

If the methods disclosed herein are applied during post-emergence to the green parts of the plants, growth likewise stops drastically a very short time after the treatment and the weed plants remain at the growth stage of the point of time of application, or they die completely after a certain time, so that in this manner competition by the weeds, which is harmful to the crops, is eliminated at a very early point in time and in a sustained manner.

In an embodiment, the plant comprises weeds, preferably Amaranthus palmeri, Echinochloa crusgalli, black-grass, wild oats, rye-grasses, meadow-grasses, common chickweed and/or mayweeds in winter wheat. The glutamine synthetase inhibitor, e.g. the herbicide glufosinate ammonium, deletes the weeds and increases therefore the yield of the plant. The plant may also comprise other weeds.

In an embodiment, the method is provided, wherein the application rate model is further based on environmental data, preferably humidity data, light data, and/or temperature data. The environmental data may be provided from central databases or cloud applications and/or commercial providers. The environmental data may be derived from measurement devices mounted to the agricultural vehicle. The accuracy of the application rate model may be increased by the environmental data. The application rate model may comprise an evaluation algorithm, which may be based on the results of a machine-learning algorithm, wherein as training data for such a machine-learning algorithm, test result data are used showing the dependency of the glutamine synthetase inhibitor, e.g. glufosinate-efficacy on nitrogen bioavailability of a plant. However, as an alternative also statistical algorithm may be applied. Thereby, a demand-driven application concept for a glutamine synthetase inhibitor, e.g. the herbicide glufosinate (GF), can be provided, e.g. an application concept with optimum quantity/benefit values.

In an embodiment, the method provided, wherein the application rate is provided to a control device of an agricultural application vehicle, preferably a smart sprayer, a drone and/or a tractor with an application device. The control device may use the application rate to control an application device to apply a glutamine synthetase inhibitor, e.g. glufosinate or a salt thereof, on the plants in the agricultural field. The determination of the application rate and provision of the determined application rate and the application of a glutamine synthetase inhibitor, e.g. glufosinate or a salt thereof, may be carried in real time. The application rate may be provided to an overall database for further analysis.

A further aspect of the present disclosure relates to a use of satellite image data and/or nitrogen content data in a method described above.

A further aspect of the present disclosure relates to a system for providing application rate data for an agricultural field, comprising: a providing unit configured to provide an application rate model for a plant, wherein the application rate model is configured to describe a relationship between a nitrogen content and an application rate of a glutamine synthetase inhibitor, e.g. glufosinate or a salt thereof; an obtaining unit configured to obtain nitrogen content data of at least a section of the agricultural field; an inputting/providing unit configured to input/provide the nitrogen content data of the at least one section of the agricultural field in the application rate model; a determining unit configured to determine the application rate of a glutamine synthetase inhibitor, e.g. glufosinate or a salt thereof, of the at least one section of the agricultural field using the application rate model; a providing unit configured to provide the application rate of a glutamine synthetase inhibitor, e.g. glufosinate or a salt thereof, for the at least one section of the agricultural field. The providing unit, the obtaining unit, the inputting/providing unit, the determining unit, and the providing unit may be separate hardware based CPUs, virtual software units executed one or more hardware CPUs.

A further aspect relates to a computer program element which when executed by a processor in a system described above is configured to carry out steps of the method described above. The computer program element might therefore be stored on a computing unit, which might also be part of an embodiment. This computing unit may be configured to perform or induce performing of the steps of the method described above. Moreover, it may be configured to operate the components of the above described system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

It has been discovered that there is a negative correlation between the amount/content of nitrogen in a plant or in the soil area around a plant and the phytotoxic effects of a glutamine synthetase inhibitor, e.g. glufosinate. Notably, until now, the skilled person assumed that a higher nitrogen content in a plant or in an area around a plant may increase the phytotoxic effects of a glutamine synthetase inhibitor, e.g. a glufosinate, application to the plant. It is known that the application of a glutamine synthetase inhibitor, e.g. glufosinate, to plants alone may elevate the ammonia levels in tissues, halting photosynthesis and resulting in plant death (cf. e.g. Topsy Jewell in “Pesticides News”, No. 42, December 1998, pages 20 and 21). In turn, the addition of nitrogen sources such as in fertilizers would be assumed to impose additional stress on the same biochemical pathways and even increase the level of toxic ammonia in the plants, thus increasing the phytotoxic effect of a glutamine synthetase inhibitor, e.g. glufosinate. By contrary, it has been discovered that higher levels of nitrogen in the plant, or the soil area around the plant reduce phytotoxicity of a glutamine synthetase inhibitor, e.g. glufosinate.

Accordingly, the application rate model typically includes a negative correlation of the amount/content of nitrogen in a plant or the soil area around the plant and the phytotoxic effect of a glutamine synthetase inhibitor, e.g. glufosinate.

Of course, phytotoxicity may be desirable in case of controlling weeds, whereas it may be undesirable in case of crops, ornamental plants, etc. Hence, by another way of consideration of the above findings, the application rate model typically includes a positive correlation of the amount/content of nitrogen in a plant or the soil area around the plant and the application rate of a glutamine synthetase inhibitor, e.g. glufosinate, to reach a desired herbicidal effect, e.g. in quantity.

The present disclosure thus enables both an intelligent order of application of fertilizers and a glutamine synthetase inhibitor, e.g. glufosinate, to reduce application rates of the herbicide while reducing the phytotoxic effect on desirable plants; and a fine-tuning of a glutamine synthetase inhibitor, e.g. glufosinate, application rates based on a given nitrogen content in the plant or the soil area around the plant.

Accordingly, it has been found that higher amounts of nitrogen in a plant or in the soil around a plant may protect the plant against phytotoxic effects of a glutamine synthetase inhibitor, e.g. glufosinate. Based on this knowledge, it is possible, for example by means of fertilizers, to selectively apply nitrogen to a plant in order to protect it against a subsequent treatment with a glutamine synthetase inhibitor, e.g. glufosinate. This can be based on the negative correlation disclosed here between a level of nitrogen content and the phytotoxicity with glufosinate as an example for a glutamine synthetase inhibitor (cf. FIG. 2 and FIG. 3). Such targeted protection of a crop plant offers the possibility of a corresponding increase in yield, even when higher amounts of a glutamine synthetase inhibitor, e.g. glufosinate, are used.

The term “phytotoxic effect” as used herein refers to the toxicity of a given substance against a plant, be that a desired vegetation such as crops or ornamental plants or an undesired vegetation such as weeds.

### BRIEF DESCRIPTION OF THE DRAWINGS

In the following, the present disclosure is described exemplarily with reference to the enclosed figure, in which

FIG. 1 is a schematic view of a method according to the preferred embodiment of the present disclosure;

FIG. 2 show test result data for GLXMA;

FIG. 3 show test result data for GLXMA;

FIGS. 4 to 10 show further test result data for other plants; and

FIG. 11 is a schematic view of a system according to an embodiment of the present disclosure.

### DETAILED DESCRIPTION OF EMBODIMENT

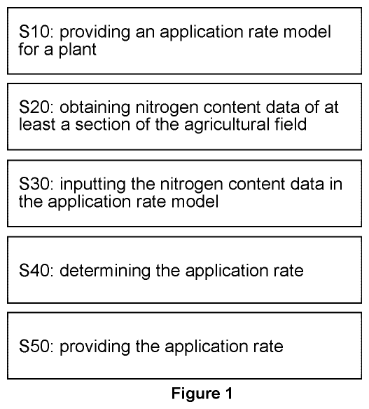

FIG. 1 is a schematic view of a method according to the preferred embodiment of the present disclosure. In the following, an exemplary order of the steps according to the present disclosure is explained. However, the provided order is not mandatory, i.e. all or several steps may be performed in a different order or simultaneously.

The method for providing application data for an agricultural field below can be summarized as follows. The nitrogen content of a plant and/or a soil in a section of agricultural field is determined and further provided to application rate model of a plant and a glutamine synthetase inhibitor, e.g. glufosinate or a salt thereof. Based on the application rate model an application rate for a glutamine synthetase inhibitor, e.g. glufosinate or a salt thereof, treatment of the plant in the section of the agricultural field is determined. The determined application rate is further provided to a user, a database or directly to a control of an application device.

In a first step S10 an application rate model for a plant is provided, wherein the application rate model is configured to describe a relationship between a nitrogen content and an application rate of a glutamine synthetase inhibitor, e.g. glufosinate or a salt thereof. The application rate model comprises in the present embodiment mathematical relations between input parameters and output parameters. The input parameter is the nitrogen content. The output parameter is the application rate. The application rate model relates to a specific plant, e.g. crop comprising weed Amaranthus palmeri. The mathematical relations may comprise a statistical model derived from a design of experiments. However, the mathematical relations may also be based on factors, offsets, non-linear equations, conditions, machine learning algorithms, and/or neural networks. The application rate model may be stored in a controller of an agricultural vehicle.

In the following, an exemplary test setup and exemplary tests are explained. Such tests may provide test result data that can serve as basis for an application rate model for a glutamine synthetase inhibitor, e.g. glufosinate or a salt thereof. Such an application rate model may be based on statistical algorithms, e.g. regression algorithms, or may also be used as training data for a machine-learning algorithm.

### Material and Methods:

GLXMA (Glycine max; soybean plant) plants were grown on soil in a green house. Before separation into single pots plants were watered with demineralized water (VE-water). After separation into single pots and splitting into four different nourishing groups, the pots were individually watered with 50 ml of the respective nutrient solution. The following recipe for the full-nutrient solution (5 mM N) mentioned in the book “Diagnose des Ernährungszustandes von Kulturpflanzen”, ISBN: 978-3-86263-118-6, table 3-2, page 94 has been used:

| | | mL stock-solution - | | | |
|---|---|---|---|---|---|
| | | end volume: 2 L (ddH₂O) | | | |
| | | full- | Nitrogen (N) - | | |
| | | medium | deficiency | | |
| | concentra- | 5 | 2.5 | 1.25 | 0 |
| Stock-solution* | tion[mM] | mM | mM | mM | mM |
| Ca(NO₃)₂ | 1000 | 10 | 5 | 2.5 | — |
| KNO₃ | 1000 | 10 | 5 | 2.5 | — |
| KH₂PO₄ | 100 | 10 | 10 | 10 | 10 |
| MgSO₄ | 1000 | 4 | 4 | 4 | 4 |
| NaNO₃ | 1000 | — | — | — | — |
| CaCl₂ | 1000 | — | 5 | 2.5 | 10 |
| KCl | 1000 | — | 5 | 2.5 | 10 |
| NaCl | 100 | 1 | — | — | — |
| FeEDDHA/FeEDTA | 100 | 2 | 2 | 2 | 2 |
| H₃BO₃ | 50 | 2 | 2 | 2 | 2 |
| MnSO₄ | 50 | 1 | 1 | 1 | 1 |
| ZnSO₄ | 10 | 2 | 2 | 2 | 2 |
| CuSO₄ | 10 | 1 | 1 | 1 | 1 |
| (NH₄)₆Mo₇O₂₄ | 1 | 1 | 1 | 1 | 1 |

*the recipe for the stock solutions is shown on page 260

Plants were grown until the growth stage GS 61 (58-74 cm), where first symptoms of nutrient deficiency became visible. This included yellowing of the leaves which were watered with N-deficient media.

A spray application was performed in a high speed spray cabin with the following settings: used nozzle: TT 110 02; pressure: 3 bar; speed: 1.33 m/s; temperature: 22° C.; relative spray humidity: 55%

Spray solution: A GF-solution comprising 280 g/l glufosinate-ammonium is sprayed with an a.i. dose rate of 300 g/ha and a water rate of 200 l/ha. The control plants were sprayed with water (ddH2O) only. After spraying, all plants were watered with VE-water. A biological assessment was performed 3 and 7 days after application (daa).

In other words, to achieve an N-deficiency, the plants were separated in four different groups, which were watered with 4 different nutrient solutions. The “full” medium contained a final concentration of 5 mM N nitrogen-sources, whereas the N-deficiency media contained either 0 mM N (“null” medium) or 1.25 mM N and 2.5 mM N (“deficiency” media). Nutrient deficiency became visible at the GS 61. Fully supplied soybean plants exposed fully green leaves, whereas soybean plants supplied with N-deficient media showed symptoms of chlorosis, an indicator for N-deficiency. Plants which were supplied with the “null” media showed the most expressed symptoms of chlorosis.

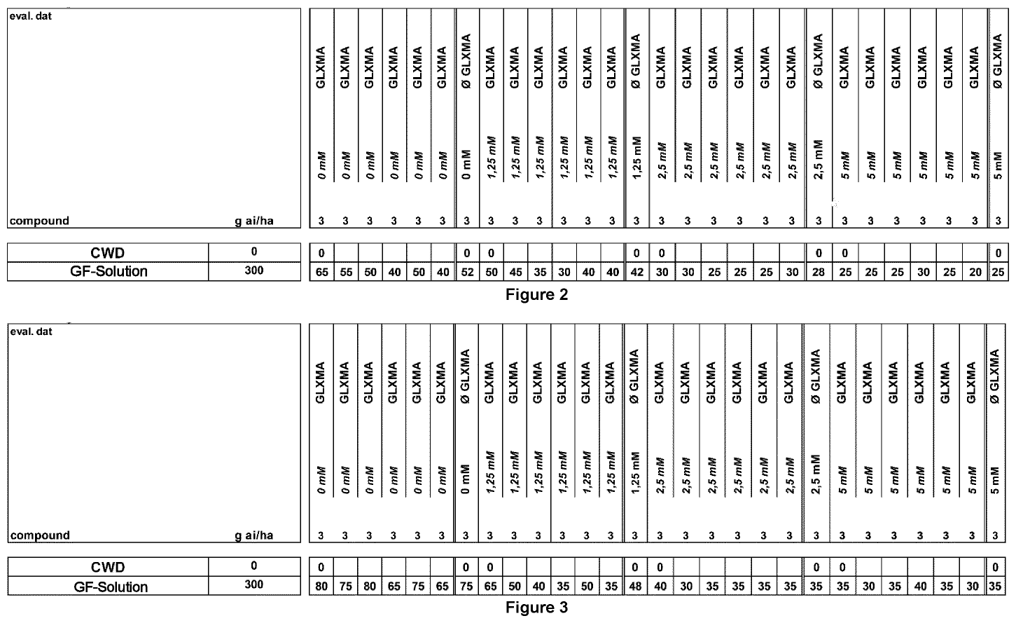

FIGS. 2 and 3 show the test results data showing a direct dependent relationship between biological glufosinate efficacy and nitrogen supply, wherein FIG. 2 shows the test result data after 3 days at GS 65 and FIG. 3 shows the test result data after 7 days at GS 69. In FIGS. 2 and 3, GLXMA is Glycine max (soybean plant), G ai/ha is grams of active ingredient per hectare, CWD is the control group without treatment, GF-Solution is the solution comprising 280 g/l glufosinate-ammonium. At full (5 mM) or half full (2.5 mM) nitrogen supply was detected and rated to an average of 35. Lowering the nitrogen supply to a level of 1.25 mM increases the efficacy of glufosinate to 48, which is visibly by more chlorotic and necrotic tissue. Under complete nitrogen deficiency the symptoms are boosted and result in an average efficacy rating of 75.

The exemplary results demonstrate the dependency of the glufosinate-efficacy on nitrogen bioavailability of plants, which can be used for the application rate model providing a demand-driven application concept for the herbicide glufosinate (GF). These exemplary results shown in FIGS. 2 and 3 illustrate that higher amounts of nitrogen in a plant or in the soil around a plant, may protect the plant against the phytotoxic effect of glufosinate. As mentioned, based on this knowledge, it is possible, for example by means of fertilizers, to selectively apply nitrogen to a plant in order to protect it against a subsequent treatment with a glutamine synthetase inhibitor, e.g. glufosinate.

Such an application model may be based on statistical models and/or on a machine-learning algorithm. Such tests may also be performed for different climates, plant species, soil characteristics, or even site-specific.

In step 20 the nitrogen content data of at least a section of the agricultural field is obtained. The nitrogen content data is derived by a measurement with a NIR spectrometry sensor of the nitrogen content of the crop plant or a part of the crop plant which is within the at least one section of the agricultural field. The NIR spectrometry sensor is be mounted on an agricultural vehicle. The measurement is carried out during a treatment of the agricultural field and directly provided to the controller of the agricultural vehicle storing the application rate model.

In step S30 the nitrogen content data of the at least one section of the agricultural field is inputted in the application rate model. The nitrogen content data is inputted via an interface into the application rate model.

In step S40 the application rate of the herbicide of the at least one section of the agricultural field is determined using the application rate model. The application rate comprises a minimum value and a maximum value. The minimum value is directly derived from the necessary amount of the herbicide for a sufficient treatment of the plant based on the equations provided by the statistical model of the application rate model. The maximum value is derived from state regulations.

In step S50 the application rate of the herbicide for the at least one section of the agricultural field is provided to a control device of an application device, preferably a smart sprayer. The control device uses the application rate to control the smart sprayer to apply a glutamine synthetase inhibitor, e.g. the glufosinate ammonium, on the crop in the agricultural field. The determination of the application rate and provision of the determined application rate and the application of the herbicide is carried out in real time.

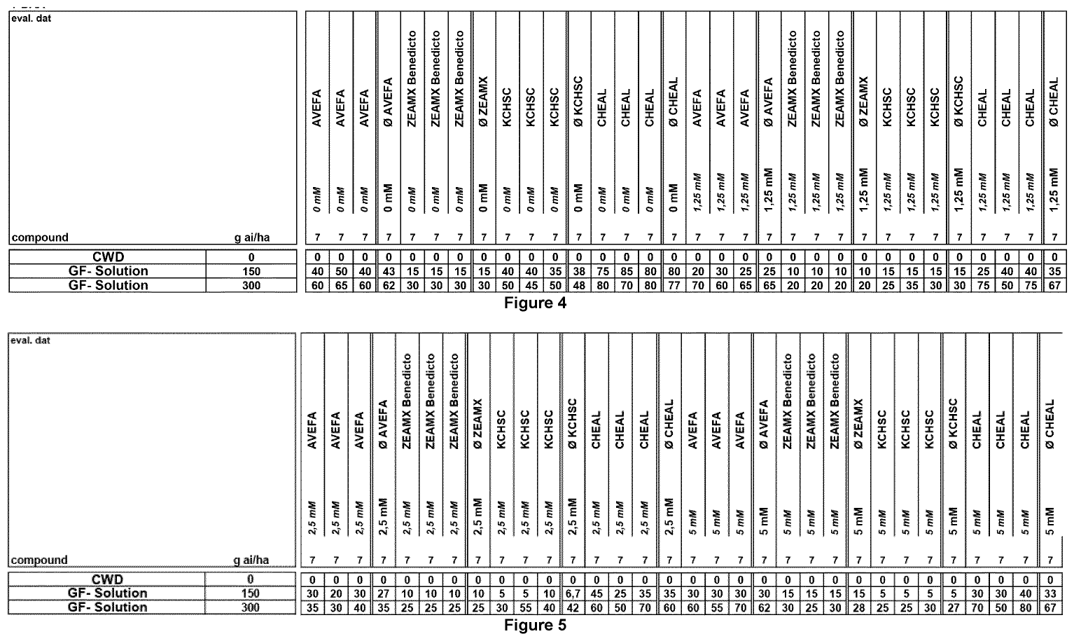

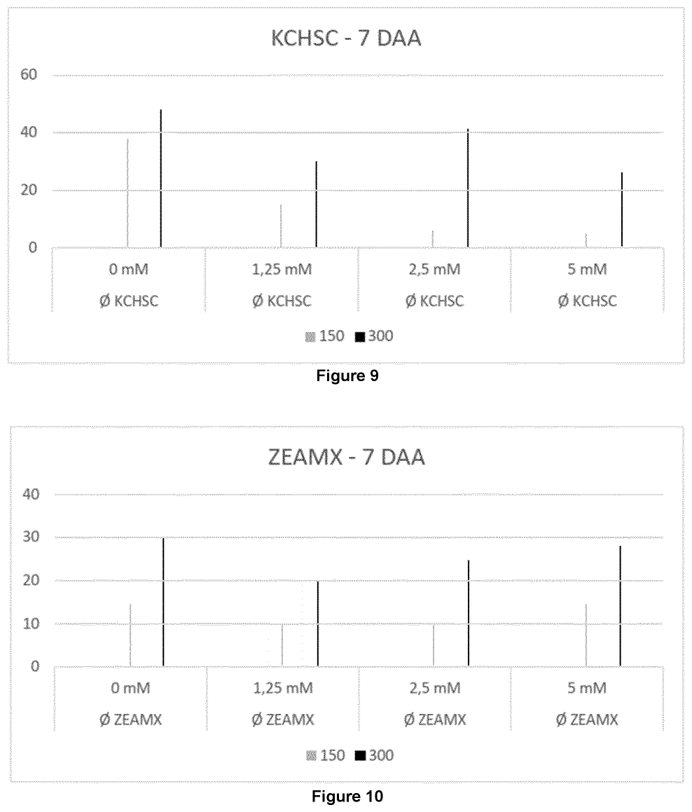

As explained above, an application model may be based on further test with respect to different climates, plant species, soil characteristics, or even site-specific. FIGS. 4 to 10 show test result data for the test described above, which was carried out for different plants, namely for Avena fatua (AVEFA), Chenopodium album (CHEAL), Bassia scoparia (KCHSC) and Zea mays (ZEAMX). Also here, the test result data with respect to these plants showing a direct dependent relationship between biological glufosinate efficacy and nitrogen supply.

A spray application was performed in a high speed spray cabin with the following settings: used nozzle: TT 110 02; pressure: about 2.5 bar; speed: about 1.2 m/s; temperature: about 22.8° C.; relative spray humidity: about 42%.

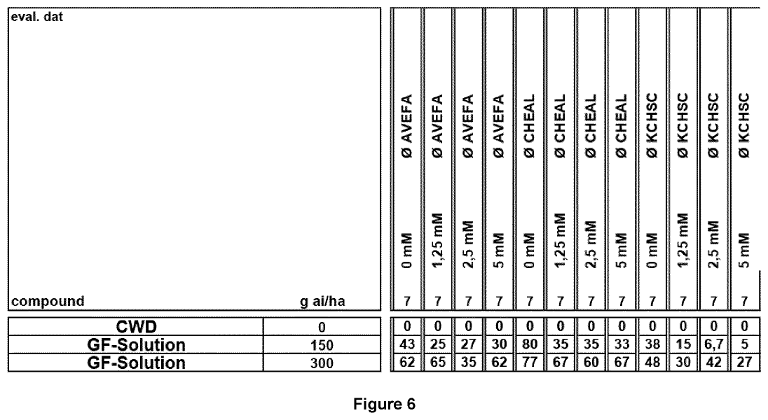

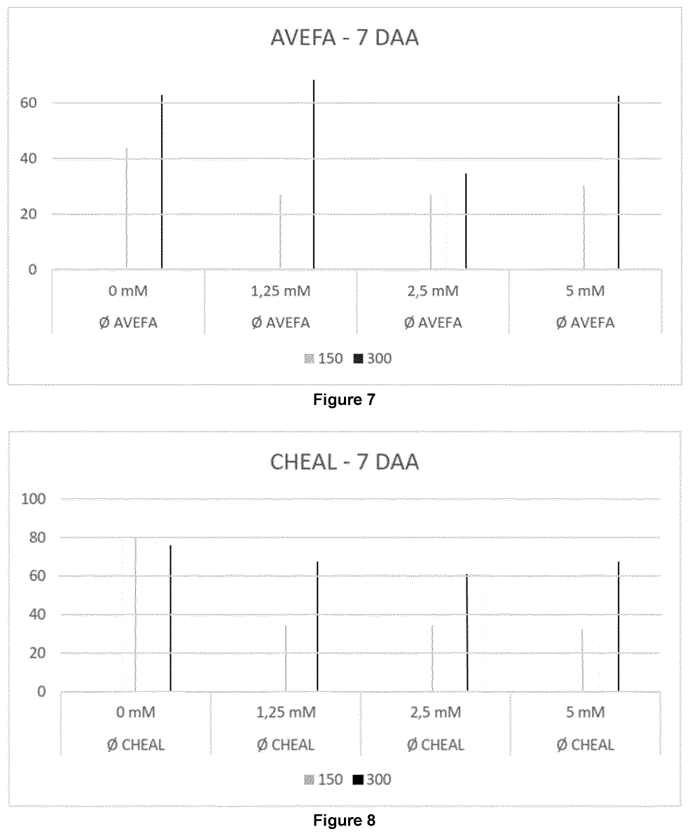

Spray solutions: Also here, the GF-solution comprised 280 g/l glufosinate-ammonium, but which has been sprayed here with two different dose rates, namely (i) with a dose rate of 300 g/ha and a water rate of 200 l/ha and (ii) with a dose rate of 150 g/ha and a water rate of 200 l/ha. Also here, the control plants were sprayed with water (ddH2O) only. After spraying, all plants were watered with respective fertilizer solution. A biological assessment was performed 7 days after application (daa). The presentation of the test data in FIGS. 4 and 5 corresponds to the presentation in FIGS. 2 and 3, with the addition of the results for the further dose rate. In FIG. 6, the respective average values from FIGS. 3 and 4 are summarized for the sake of clarity. FIGS. 7 to 10 show the average values of FIG. 6 as bar graphs.

As a result, the further exemplary test result data demonstrate the dependency of the glufosinate-efficacy on nitrogen bioavailability of plants, which can be used for the application rate model providing a demand-driven application concept for the herbicide glufosinate (GF). Also the further exemplary results, shown in FIGS. 4 to 10, confirm that higher amounts of nitrogen in a plant or in the soil around a plant, may protect the plant against the phytotoxic effect of glufosinate. As mentioned, based on this knowledge, it is possible, for example by means of fertilizers, to selectively apply nitrogen to a plant in order to protect it against a subsequent treatment with a glutamine synthetase inhibitor, e.g. glufosinate.

Based on these test result data, an application rate model can be provided configured to determine a higher application rate of a glutamine synthetase inhibitor for sections of an agricultural field having a higher nitrogen content compared to sections of an agricultural field having a lower nitrogen content.

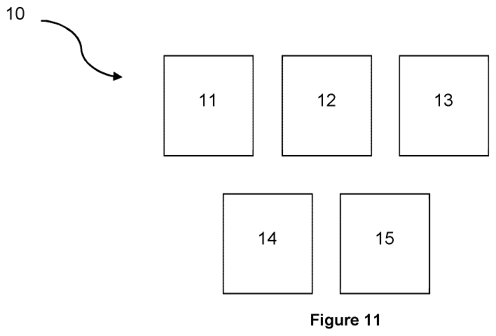

FIG. 11 is a schematic view of a system according to a preferred embodiment of the present disclosure. The system 10 provides application rate data for an agricultural field. The system 10 comprises: a providing unit 11 configured to provide an application rate model for a plant, wherein the application rate model is configured to describe a relationship between a nitrogen content and an application rate of a herbicide; an obtaining unit 12 configured to obtain nitrogen content data of at least a section of the agricultural field; an inputting unit 13 configured to input the nitrogen content data of the at least one section of the agricultural field in the application rate model; a determining unit 14 configured to determine the application rate of the herbicide of the at least one section of the agricultural field using the application rate model; a providing unit 15 configured to provide the application rate of the herbicide for the at least one section of the agricultural field.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular the steps S10 to S40 can be performed in any order, i.e. the present invention is not limited to a specific order of these steps. Moreover, it is also not required that the different steps are performed at a certain place or at one place, i.e. each of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

S10 providing an application rate model for a plant
S20 obtaining nitrogen content data of at least a section of the agricultural field
S30 inputting the nitrogen content data in the application rate model
S40 determining the application rate
S50 providing the application rate
10 system
11 providing unit
12 obtaining unit
13 Inputting unit
14 determining unit
15 providing unit

1. A computer-implemented method for providing application data for an agricultural field, comprising the following steps:
providing an application rate model for a plant, wherein the application rate model is configured to describe a relationship between a nitrogen content and an application rate of a glutamine synthetase inhibitor (S10);
obtaining nitrogen content data of at least a section of the agricultural field (S20);
providing the nitrogen content data of the at least one section of the agricultural field to the application rate model (S30);
determining the application rate of the glutamine synthetase inhibitor of the at least one section of the agricultural field using the application rate model (S40); and
providing the application rate of the glutamine synthetase inhibitor for the at least one section of the agricultural field (S50).

2. The method according to claim 1, wherein the nitrogen content data is derived by a measurement of the nitrogen content of a plant or a part of the plant which is within the at least one section of the agricultural field.

3. The method according to claim 1 or 2, wherein the nitrogen content data is derived by a measurement of the nitrogen content of a soil or a part of the soil which is within the at least one section of the agricultural field.

4. The method according to claim 1, wherein the application rate model is based on the correlation that within a minimum value and a maximum value of an application rate of the glutamine synthetase inhibitor for the section of the agricultural field, a higher application rate is determined for sections with higher nitrogen content compared to sections with lower nitrogen content.

5. The method according to claim 1, wherein the application rate model describes a negative correlation of the nitrogen content and a phytotoxic effect of the glutamine synthetase inhibitor.

6. The method according to claim 1,
wherein the nitrogen content data is derived by an analysis of satellite image data of the at least one section of the agricultural field; and
wherein the satellite image data comprises geographical location data and image data of the least one section of the agricultural field.

7. The method according to claim 1, wherein the nitrogen content data is derived by a measurement with a near-infrared (NIR) spectrometry sensor of the nitrogen content of a plant, a part of a plant and/or the nitrogen content in the soil around or at least partially around a plant.

8. The method according to claim 1, further comprising providing an application rate map for the agricultural field, wherein the application rate map is determined based on the at least one determined application rate for the section of the agricultural field, wherein the application rate map preferably comprises different sections of the agricultural field with different application rates.

9. The method according to claim 1, wherein the application rate model is further based on environmental data comprising, humidity data, light data, and/or temperature data.

10. The method according to claim 1, wherein the application rate model comprises an evaluation algorithm, which is based on the results of a machine-learning algorithm, and wherein as training data for such a machine-learning algorithm, test result data are used showing the dependency of the glutamine synthetase inhibitor efficacy on nitrogen bioavailability of a plant.

11. The method according to claim 1, wherein the application rate is provided to a control device of an agricultural application vehicle comprising a smart sprayer, a drone and/or a tractor with an application device.

12. Use of satellite image data and/or nitrogen content data in a method according to claim 1.

13. Use of test result data showing the dependency of the glutamine synthetase inhibitor efficacy on nitrogen bioavailability of a plant as training data of a machine-learning algorithm.

14. A system (10) for providing application rate data for an agricultural field, comprising:
a providing unit (11) to provide an application rate model for a plant, wherein the application rate model is configured to describe a relationship between a nitrogen content and an application rate of a glutamine synthetase inhibitor;
an obtaining unit (12) configured to obtain nitrogen content data of at least a section of the agricultural field;
a providing unit (13) configured to provide the nitrogen content data of the at least one section of the agricultural field in the application rate model;
a determining unit (14) configured to determine the application rate of the glutamine synthetase inhibitor of the at least one section of the agricultural field using the application rate model; and
a providing unit (15) configured to provide the application rate of the glutamine synthetase inhibitor for the at least one section of the agricultural field.

15. A non-transitory computer-readable medium having instructions encoded that when executed by a processor in a system, cause the processor to carry out a method according to claim 1.
